(19) United States
(12) Patent Application Publication
(10) Pub. No.: US 2007/0199648 A1
(43) Pub. Date: Aug. 30, 2007

(54) Method for producing blanks from cardboard and device for implementing the method

(76) Inventor: Detlef Hulverscheidt JR., Remscheid (DE)

Correspondence Address: Scott R Foster;Pandiscio & Pandiscio, 470 Totten Pond Road, Waltham, MA, 02451-1914, US

(21) Appl. No.: 10/562,321

(22) PCT Filed: Jun. 12, 2004
(86) PCT No.: PCT/EP04/06359

§ 371 Date: Oct. 12, 2006

(30) Foreign Application Priority Data
Jun. 26, 2003 (DE) 103 28 891.0

(51) Int. Cl. B32B 38/04; B32B 37/12

(52) U.S. Cl. 156/252; 156/256; 156/510; 156/517; 156/578; 156/513

(57) ABSTRACT

To improve a conventional device for processing blanks made of cardboard so that they have processing lines running not only in the longitudinal and transverse directions, there is provided a processing head that is movable at a distance above the cardboard blank, which can be caused to travel to any point within the outline of the cardboard blank, and that carries a processing tool that can be activated and deactivated, and that can be caused to travel by an EDP system after activation, to any point on the diagonal processing line.

This invention relates to a method pursuant to the preamble of claim 1 and a device pursuant to the preamble of claim 11.

Originally rectangular cardboard blanks are used to produce blanks from cardboard, including corrugated cardboard and solid paperboard among others. These cardboard blanks are prepared by various processing parameters (e.g. cutting, creasing, die-cutting, gluing . . . ) so that they correspond to the layout of a box structure to be manufactured, which can then be set up.

Box structures, on the one hand, mean corrugated cardboard cartons, folding boxes, setups, and all comparable cardboard items in the industrial sector, for which a finished blank is made by processing lines, cut lines, fold lines, perforated lines, or the like that run in the longitudinal or transverse direction, as the case may be, from an originally rectangular piece of cardboard, from which the finished box structure can then be set up by simple folding or the like.

It is a special feature, of course, that such blanks have processing lines that run not only in the longitudinal or transverse directions, as the case may be, but also other processing lines that run neither in the longitudinal nor in the transverse direction.

For example, these may be openings in the side faces of a box that serve as handles when carrying the box, or simply diagonal cut lines, perforation lines, or the like, whose direction does not coincide with the longitudinal or with the transverse direction of the box.

Typical examples of this are the blanks designated in the internationally recognized FEFCO code with the numbers 215 to 227, 363, 304, 307 to 309, 314, 321 to 323, 330, 416, 421 to 429, 431, 432, 434, 435 to 440, 442 to 451, etc. All of these box blanks, besides the usual processing lines, fold lines, cut lines, or the like running in the longitudinal or transverse direction, also have such processing lines that run diagonally, but in no case perpendicular to the usual feed direction of the cardboard blanks, and therefore can be manufactured only with the blank standing still if appropriate processing modules are integrated into the production line.

These processing modules, however, are very tedious to change over for box and cardboard blanks with different codes, so that the invention faces the task of proposing a method and a device that avoid this drawback.

The solution to this task is found in the features of claims 1 and 12.

The invention provides the advantage that a processing module easily integrated any production process, once it is programmed, can prepare almost any arbitrary cardboard blank completely for the end product, without needing to change over the particular processing module for differently coded cardboard blanks.

This advantage is achieved by the fact that the processing device necessary for this is movable for any cardboard blank to be processed so that the processing head of the processing device provided with the particular fitting tool can begin the desired type of processing at any point on the cardboard blank and lead to the end with a prescribed advance in the direction of processing, and then can stop by deactivating the processing device.

Possible processing steps besides the sequence of cut lines, fold lines, and perforation lines also include the application of adhesives or local imprinting, with this list not being at all complete.

It is assumed for this invention that the “production line” does not have to exist in just one plant.

It is important for the multiple different production steps to be executed consecutively, so that the invention can also be implemented as a single production step in a single operation set up for it. The device pursuant to the invention can serve this purpose as a separate stand-alone machine.

The invention is based on the principle of a plotter or an EDP-controlled robot arm that cuts, perforates, folds, imprints, glues, etc., any cardboard blank passing by it in the predetermined manner, in a practically continuous pass-through. In those directions that differ from the usual direction of processing or direction of transport of the cardboard blank and from the direction perpendicular to it, the advance of the processing device occurs after predetermined starting positions have been reached.

The method pursuant to the invention can naturally be used only when needed, while the machine module that is ready to carry out these processing steps is no obstacle to processing lines that run only in the longitudinal or transverse directions, as the case may be, by just turning it off during conventional manufacturing cycles.

The processing head of the processing device pursuant to the invention is suitably controlled by an EDP system. The particular data specific for the blank are stored in memory there and can be integrated into the processing program as needed, if one or more such cardboard blanks are to be manufactured.

The special advantage of the invention, therefore, lies in the fact that even short or very short runs can be produced economically by simply programming the particular processing steps in the necessary diagonal processing direction, or by polling data from memory, because the corresponding setup times are limited to the polling from memory. The advantages of the invention for longer runs are obvious. For short and very short runs, the invention offers the advantage of low cost with short setup times.

The invention differs importantly from the usual processing methods in the focused processing of the cardboard blank with a given processing direction diagonal to the longitudinal direction, which generally coincides with the direction of processing or the direction of transport of the cardboard blank.

Therefore, it is essential for the invention that the particular processing head of the processing device assumes a given distance from the cardboard during its approach to the processing position on the cardboard blank, and can be activated only after reaching the point of processing. After activation, the preferably EDP-controlled advance of the processing device occurs in the particular prescribed direction of processing.

The invention can readily be integrated into ordinary processing lines. Depending on the processing program, it may be suitable to use the process steps of the invention before or after the processing steps that serve to produce the processing lines in the longitudinal or transverse directions, as the case may be. The invention for the first time provides the ability to integrate a device suitable for the procedural steps in the form of a cutting, creasing, perforating, milling, or marking plotter into a so-called in-line machine that operates continuously or in stop-and-go mode, with which all work steps are executed on the workpiece, starting from a rectangular initial shape to the optionally finished and folded box, along a continuously straight-line machine centerpoint.

When the invention is used as a gluer, what has been said above applies appropriately both to such in-line machines and to so-called stand-alone operation, since the processing module can be operated independently of the place of installation.

The invention is thus viewed particularly in the form of a separate processing module that can easily be integrated into any ordinary in-line processing machine, or in stand-alone operation only has to be equipped with feed and delivery devices. Alternatively, a separate gluing plotter can also be coupled with a subsequent accessory device for folding or a manual folding station. For this purpose, the use of a glue with a correspondingly longer setup time is suggested.

However, the production of cut lines that are produced by a processing device designed as a cutter is of particular importance.

The linear processing of the workpiece also permits the cut lines to be continuous except for predetermined hold points. These hold points fasten the waste chip to the rest of the product and can later be broken out easily.

Also important is the capability, alone or in combination with a cutter, of applying adhesive to the cardboard blank on predetermined lines.

Arranging glue points at any arbitrary place on the cardboard blank for this purpose is just as important as the positioning of glue lines whose direction is different from the longitudinal or transverse directions.

The device for implementing the method operates by the plotter principle, or that of a robot arm, that is mounted in fixed position outside of the seat area of the cardboard blank, and like the processing head of a plotter,. is able to move to move to any point on the cardboard blank.

Only at the particular processing location within the borders of the cardboard blank is the processing head activated, and it then travels along the prescribed processing line under EDP control.

To this end, the processing head can rest on two positionally fixed guidance systems movable perpendicular to one another, that are oriented parallel to the surface of the cardboard. On the other hand, a rotating and extendible boom like a robot arm can also be used.

The invention is not limited to a single processing head. For accelerated processing, two or more processing heads operating in synchronism or staggered in time can also be provided.

For the different types of processing, namely cutting, perforating, scoring, creasing, marking, etc., processing heads with differing functional modes are provided, which are attached to the processing device, preferably interchangeably.

The invention is suitable also for applying glue or hot melt. Used for this are glue applicators or heated hot melt nozzles that can be moved according to the invention to any point within the contour of the box.

It is especially advantageous that a pressing station may follow in this case of a device pursuant to the invention, in order to give the adhesive or glue the necessary time under pressure to set up.

The invention is described below in further detail with reference to examples of embodiment. The Figures show:

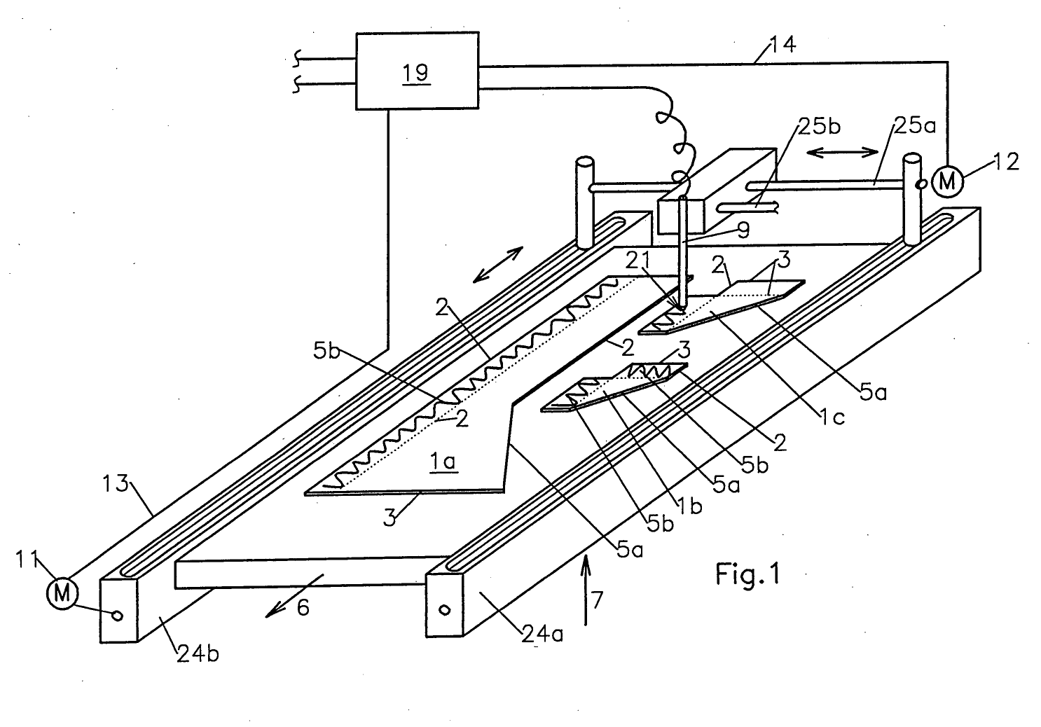

FIG. 1 a first embodiment of the invention realized as a gluing plotter,

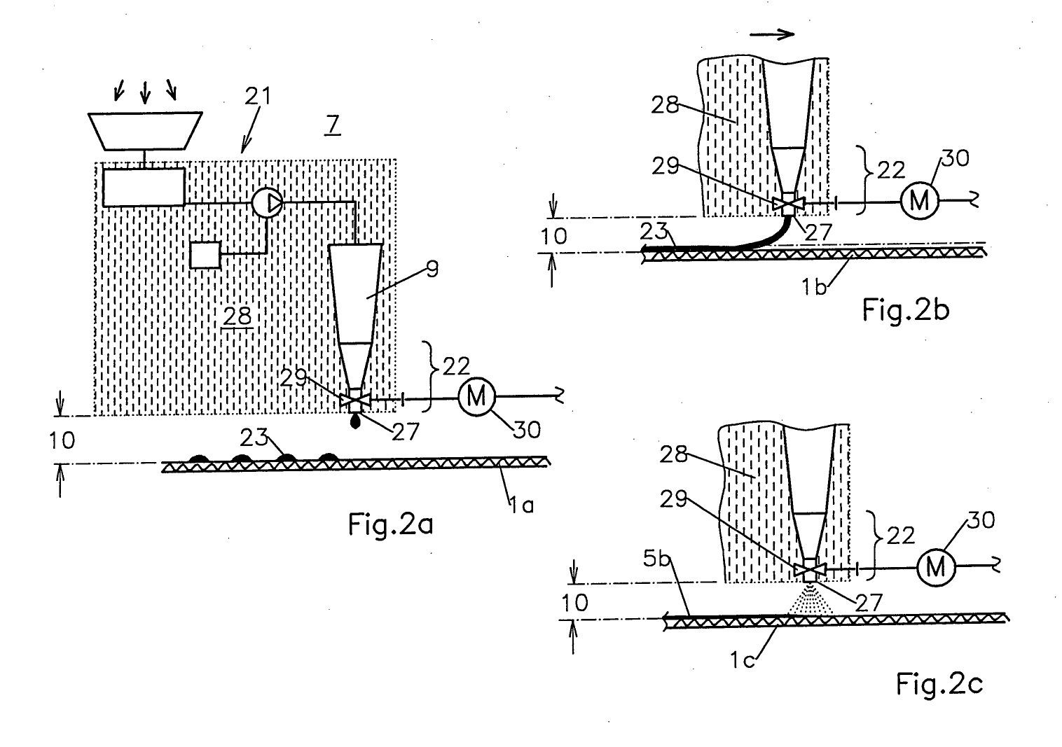

FIG. 2a an embodiment of the invention for point application of adhesive,

FIG. 2b an embodiment for linear adhesive application,

FIG. 2c an embodiment of the invention for area application of adhesive,

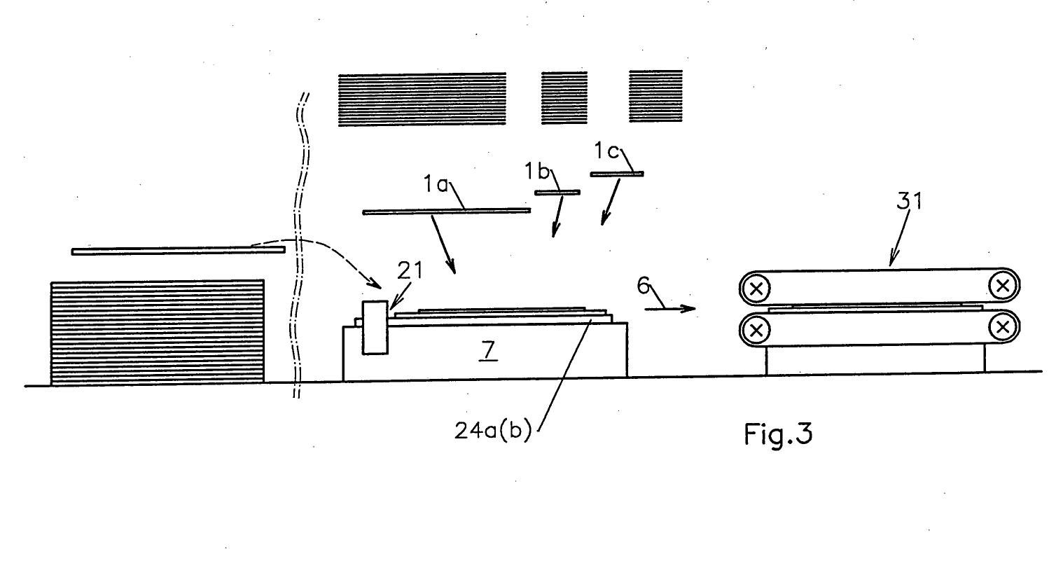

FIG. 3 an embodiment of the invention corresponding to FIG. 1 followed by a pressing station,

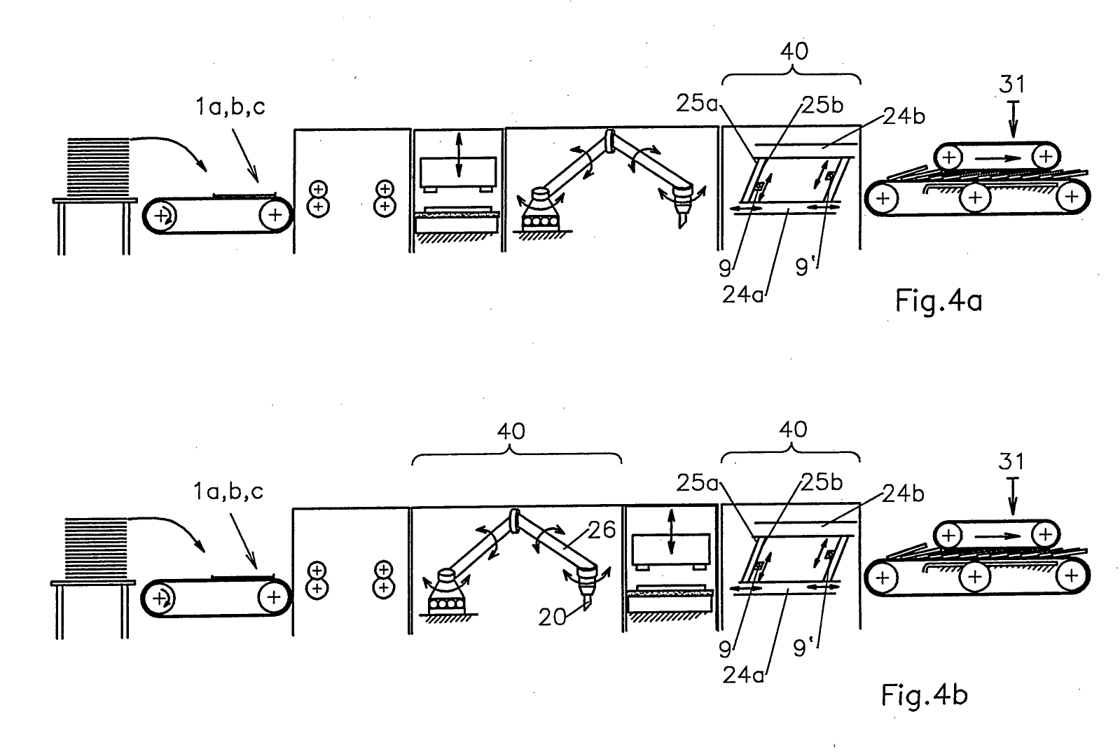

FIG. 4a an embodiment of the invention with cutting plotter and adhesive plotter as well as pressing station,

FIG. 4b an embodiment according to FIG. 4a with preceding cutting plotter,

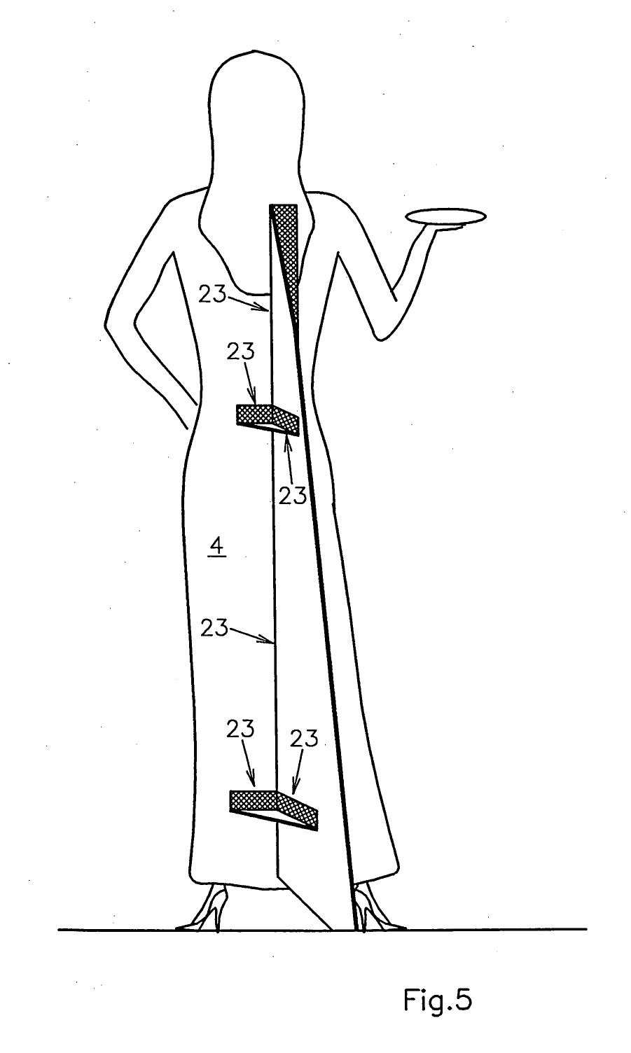

FIG. 5 a cardboard mount for advertising purposes corresponding to the manufacturing step of FIG. 1,

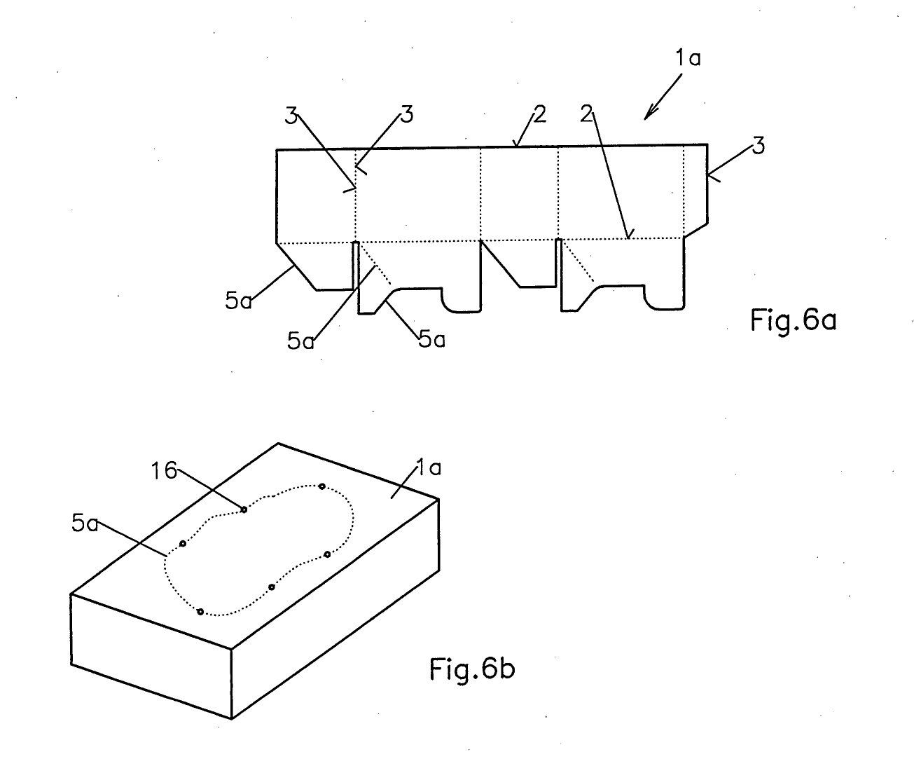

FIG. 6a an embodiment for a cardboard blank (FEFCO code 0700),

FIG. 6b an embodiment of a cutout with hold points.

If not otherwise stated below, the following description applies to all of the figures in every case.

The figures show the method for producing cardboard blanks. The cardboard blanks 1a, b, c were made from a piece of cardboard originally of rectangular shape. Depending on preceding processing, a layout of the box structure to be manufactured was prepared from the originally rectangular piece of cardboard by longitudinal cut lines 2 or processing lines of other kinds, and also by transverse cut lines 3 or other kinds of processing lines, as the case may be.

Among the other kinds of processing lines included may be the fold lines indicated in FIGS. 1 and 6a by dotted lines, along which the cardboard blank is to be folded to form the finished paperboard structure.

It is important that beyond the processing lines running in the longitudinal direction and in the transverse direction, as the case may be, there are also other processing lines 5a, 5b that run in neither the longitudinal direction nor in the transverse direction. Among them, for example, are the cut lines 5a according to FIGS. 1 and 6a and the adhesive lines 5b according to FIG. 1.

Since such cardboard blanks are generally manufactured with a given direction of transport 6 that coincides with the direction of processing in a machine corresponding to FIGS. 4a, 4b, the processing lines 5a, 5b running diagonally cannot be introduced directly into the cardboard blanks 1a to 1c in the pass-through process.

This is where the invention comes in.

Specifically, the other processing lines 5a, 5b, that run in neither the longitudinal nor the transverse direction, are produced by a processing device 7 movable parallel to and relative to the plane of the cardboard to be blanked out. To this end, the processing device 7 has a processing head 9, 9′ that can be moved at a given distance 10 from the cardboard to any point on this processing line 5a, 5b. After the processing head 9, 9′ has traveled to the beginning point in question, the processing head is activated for processing and is then driven in the activated state along the processing lines 5a, 5b with controlled feed 11-13, 12-14 in the direction of processing.

The particular direction of processing for the other processing lines 5a, 5b, obviously does not coincide with the usual direction of processing 6, which corresponds to the direction of transport of the cardboard blank (see FIGS. 4a, b).

For this purpose the processing device 7 has a longitudinal drive 11 that can be controlled through an appropriate control line 13 in the programmed manner. This also applies appropriately to the transverse drive 12, which is connected through the control line 14 to an EDP system 19.

The feeds of both drives 11, 12 are therefore controlled by the EDP system 19 through the particular associated control lines 13, 14, and then depart along the other processing lines 5a, 5b of the particular processing direction, while ordinarily the cardboard blank is held on its bed.

This can be accomplished, for example, by producing a partial vacuum beneath the cardboard blank.

FIGS. 4a, 4b show that the other processing lines 5a, 5b can be produced in a process step before or after the processing steps to produce the longitudinal and possibly transverse cut lines 2, 3.

To do this, FIG. 4a shows a conventional in-line machine in which cardboard blanks 1a, b, c, etc., are first fed in from a stack to enter the processing line. Creasing is performed in a first machine module, for example.

In the second processing module, a flat-bed die is provided that in this case makes the cuts in the longitudinal and transverse directions on the cardboard blank.

In the following machine module, a processing device 7 in the form of a robot arm pursuant to the invention is shown, which carries a cutter 20 on its end to produce the diagonal cuts in the cardboard blank.

Another processing device 7 follows this, which in this case is designed as an adhesive plotter. In that position, the adhesive lines 5b are applied to the cardboard blanks according to the detailed illustration in FIG. 1b.

The collapsed and preglued box is then held in a following pressing station 31 until the adhesive has set.

The adhesive device 21 in this case is provided with two processing heads 9, 9′ to be able to perform the gluing process faster.

The difference between the illustrations of FIGS. 4a and b consists only of the fact that in the case of FIG. 4a there are two further processing devices 7 beyond the machine module, in which lies the processing step of producing the longitudinal and possibly transverse cut lines.

In the case of FIG. 4b, the machine module that produces the diagonal cut lines 5a is located before the flat-bet die, while the adhesive plotter is beyond the flat-bed die.

It is therefore obvious that the arrangement of the device modules pursuant to the invention and the execution of the corresponding process steps can be integrated flexibly into any manufacturing process, and can optionally also be omitted if there is no need.

FIGS. 4a, b also show that the other processing lines 5a are cut lines that are produced by a processing device 7 made as a cutter 20.

To this end, the cutter device 20 has a knife facing the cardboard blank that can be operated in alternating fashion or at a standstill.

The use of cutting wheels or the like is also conceivable.

In addition to this, FIG. 6b shows that the other cut lines 5a can be continuous except for predetermined hold points 16, with the hold points 17 fastening the waste chip to the rest of the blank 18 until the waste chip is to be broken out.

In addition to this, FIG. 1 shows the use of an EDP system 19 to cause the processing head 9, 9′ of the processing device 7 to travel under program control to where the processing is to begin and end.

The EDP system 19 also functions to control and activate the cutter 20, the adhesive device 21, the knurling device (not shown), and other possible processing functions.

As FIGS. 1, 4a, 4b show in particular, the other processing lines 5b can also comprise adhesive points, with the processing device 7 for this purpose being designed as an adhesive device 21.

FIGS. 2a to 2c show further details in this regard.

The adhesive devices 21 have an adhesive reservoir from which the adhesive is transported by a pressurizing device that can also optionally be controlled by the EDP system 19.

Following the pressurizing device is the adhesive applicator 22, from which the adhesive is then discharged toward the cardboard blank 1a, b, c.

In this regard, FIGS. 2a to 2c show adhesive devices 21 in which the entire system is heated.

So-called hot melt adhesives are used here, which are kept at elevated temperature to keep them liquid until they are applied to the cardboard blank.

The adhesive applicator is likewise enclosed by the heater 28 and has a discharge valve 29 at its discharge end that has a stepper 30 controllable by an electric motor. This is likewise controlled by the EDP system 19.

FIG. 2a in this regard shows that the adhesive applicator 22 can be activated pointwise.

In this embodiment, the adhesive is applied only at points on the back of the cardboard blank.

In the case of FIG. 2b, the adhesive is applied linearly to the back of the cardboard.

Since the head of the adhesive device is always at a distance from the back of the cardboard blank, the adhesive flow leaves the opening of the discharge nozzle in the form of a catenary during the simultaneous longitudinal motion of the adhesive device 21 in the fixed processing direction.

In contrast to this, FIG. 2c shows an adhesive device that sprays the adhesive jet, so that area adhesion occurs.

In any case, however, care is taken that the adhesive applicator 22 remains activated during the controlled traveling motion.

While FIG. 1 shows the application of the adhesive lines 5b to the back of the cardboard blank 1a, b, c, it can readily be imagined by reference to FIG. 5 that this cardboard blank 1a, b, c, can serve to erect the advertising display shown there.

In the same way, however, FIG. 6a also shows that the method pursuant to the invention and the device suitable for it are also suitable for producing conventional cardboard boxes that correspond to the conventional FEFCO codes, in this case FEFCO code No. 700.

In any case, therefore, by using the invention, not only cuts lines, perforation lines, breaking lines, fold lines, etc. can be produced, but also adhesive lines of any kind in any direction, for example S-shaped, if the adhesive points 23 necessary on the finished product require this.

Serving this purpose is a first guidance system 24a, 24b on the processing device 7 with a separate drive 11 that is set in motion through the control line 13 of the EDP system 19, together with a second guidance system 25a, b with an associated transverse drive 12 that is controlled through the control line 14.

The invention can accordingly be implemented, on the one hand, by means of two fixed-location guidance systems 24, a, b; 25a, b movable perpendicular to one another, and also, as shown in particular by FIGS. 4a, b, by a processing head 9 that rests on a boom 26 that can be rotated and extended, in the manner of a robot arm.

Beyond this, two or more processing heads 9, 9′ operated in unison or staggered in time can be provided to increase the processing speed of a single cardboard blank 1a, b, c.

If the invention is used with a cutter 20, a cutter 20 pointing in the direction of the cardboard blank 1a, b, c should be used, which comprises a stationary, oscillating, or rotating knife.

Cutters that depend on the laser beam, water jet, or sand jet principles may also be practical.

Processing heads 9 that carry a perforator, a scorer, a creaser, or a marker can also be used here alternatively.

If the invention is used with an adhesive device, the processing head 9 is simply equipped with a glue nozzle 27 and is controlled in accordance with the previous disclosure.

The heater 28 is used if hot melt is used.

A discharge valve 29—preferably controlled by the EDP system 19—can be provided to control the glue nozzle 27.

This accordingly is a relay valve that is turned on or off by a control device 30 depending on a signal from the EDP system 19.

If a pressing station 31 is placed beyond the fixed-location processing station 40, which in the cases of FIGS. 4a, b is an adhesive device 21, all of the glue spots in question can be fixed in the direction of transport 6 during the further processing of the cardboard blank, until the glue has set. The pressing station here is a compression belt; alternatively, it can be a platen press station.

### LIST OF REFERENCE SYMBOLS

1a Cardboard blank
1b Cardboard blank
1c Cardboard blank
2 Longitudinal cut line, processing line
3 Transverse cut line, processing line
4 Box structure
5a Other processing line (cut line)
5b Other processing line (adhesive line)
6 Direction of processing or transport, longitudinal direction
7 Processing device
9 Processing head
9′ Processing head
10 Distance between 9 and 1a, b, c
11 Longitudinal drive
12 Transverse drive
13 Control line for 11
14 Control line for 12
16 Hold point
17 Chip
18 Useful blank
19 EDP system
20 Cutter
21 Adhesive device
22 Adhesive applicator
23 Adhesive point
24a First guidance system
24b First guidance system
25a Second guidance system
25b Second guidance system
26a, b Boom
27 Glue applicator nozzle
28 Heater
29 Discharge valve
30 Control device for 29
31 Pressing station, in this case compression belt
40 Processing station

1. Method for producing blanks from cardboard or and board-like materials for product sales purposes, whereby the workpieces originally of any initial shape are blanked by selected ones of longitudinal (2) and transverse (3) cut lines, into the a layout of a box structure (4) to be manufactured, and other processing lines (5a, 5b) that run in neither the longitudinal nor the transverse directions, wherein the other processing lines (5a, 5b) are produced by a processing device (7) movable parallel to and relative to the plane of the material to be blanked, that can be caused to travel at a prescribed distance (10) from the material to any point on the processing lines, and activated for processing, and is driven (11, 12) in the activated state along the processing lines (5a, 5b) with controlled (13, 14, 19) feed in a processing direction.

2. Method pursuant to claim 1, wherein the other processing lines (5a, 5b) are produced in a process step prior to the processing steps for producing the longitudinal and transverse cut lines (2, 3).

3. Method pursuant to claim 1 wherein the other processing lines (5a, 5b) are produced in a process step that follows in time the production of the longitudinal and transverse cut lines (2, 3).

4. Method pursuant to one of the claims 1 to 3, wherein the other processing lines (5a) are cut lines that are produced by a cutter (20).

5. Method pursuant to claim 4, wherein the other processing lines (5a) are continuous except for predetermined hold points (16), with the hold points fastening a chip (17) to a remainder of the blank (18).

6. Method pursuant to claim 5, wherein the other processing lines (5a) are produced by the cutter (20) which is controlled digitally by an associated EDP system (19).

7. Method pursuant to claim 1 wherein the other processing lines (5b) comprise adhesive points and that the processing device (7) is an adhesive device (21).

8. Method pursuant to claim 7, wherein the adhesive device (21) is digitally controlled by an associated EDP system (19) and includes an adhesive applicator (22) that can be made to travel to any point on the blank and can be activated to discharge adhesive.

9. Method pursuant to claim 8, wherein the adhesive applicator (22) can be activated pointwise.

10. Method pursuant to claim 8, wherein the adhesive applicator (22) remains activated during controlled travel motion.

11. Method pursuant to one of the claims 1 wherein the other processing lines comprise at least one of creases, perforations, milled, or marking lines, that are produced with a correspondingly designed processing device, with the processing occurring along a straight-line processing path on the workpiece with preceding and following process steps, in an in-line machine.

12. A device for producing blanks from cardboard-like material, the device comprising a fixed-location processing station (40) in which a workpiece to be processed is held, and a processing device (7) mounted in fixed location relative to the held workpiece, and a processing head (9) that can be caused to travel to any point on the workpiece, and which can be activated or deactivated depending on the particular position thereof.

13. Device pursuant to claim 12, wherein the processing head (9) rests on two fixed-location guidance systems (24a, 24b, 25a, 25b) that are movable perpendicularly to one another.

14. Device pursuant to claim 12, wherein the processing head (9) rests on a boom (26) that is rotatable and extendible.

15. Device pursuant claim 14, wherein there are at least two processing heads (9, 9′) operable in unison and at staggered times.

16. Device pursuant to claim 12, wherein the processing head (9, 9′) is provided with a cutter (20) pointing toward the workpiece.

17. Device pursuant to claim 16, wherein the cutter (20) comprises a knife.

18. Device pursuant to claim 16, wherein the cutter (20) operates by a selected one of laser, water jet, and sand jet.

19. Device pursuant to the claim 12, wherein the processing head (9) carries a perforator.

20. Device pursuant the claim 12 wherein the processing head (9) carries a scoring or creasing device.

21. Device pursuant to claim 12, wherein the processing head (9) carries a marking device.

22. Device pursuant to claim 21, wherein the processing head (9) is provided with a glue discharge nozzle (27) pointing toward the workpiece.

23. Device pursuant to claim 22, wherein the glue discharge nozzle (27) is connected to a heater (28).

24. Device pursuant to claim 22 wherein the glue discharge nozzle is provided with a controllable discharge valve (29).

25. Device pursuant to claim 12, wherein the fixed-location processing station (40) is followed by a pressing station (31).
